(19) United States
(12) Patent Application Publication
(10) Pub. No.: US 2025/0372286 A1
(43) Pub. Date: Dec. 4, 2025

(54) LAYERED VARISTOR

(71) Applicant: Panasonic Intellectual Property Management Co., Ltd., Osaka (JP)

(72) Inventors: MASASHI TAKAMURA, Hokkaido (JP); YUJI YAMAGISHI, Hokkaido (JP); SAYAKA WATANABE, Hokkaido (JP); YUTO AKIYAMA, Hokkaido (JP); KEN YANAI, Hokkaido (JP)

(21) Appl. No.: 19/299,206

(22) Filed: Aug. 13, 2025

Related U.S. Application Data
(63) Continuation of application No. PCT/JP2024/007699, filed on Mar. 1, 2024.

(30) Foreign Application Priority Data
Mar. 30, 2023 (JP) 2023-056702

(51) Int. Cl. H01C 7/105; H01C 1/148

(52) U.S. Cl. CPC H01C 7/105; H01C 1/148

(57) ABSTRACT

A layered varistor includes a sintered body, first, second, and third internal electrodes that disposed on a first interface and inside the sintered body and that do not contact one another, a fourth internal electrode that is disposed on a second interface different from the first interface and that overlaps a part of the first internal electrode and a part of the third internal electrode when viewed in a third direction, a fifth internal electrode that is disposed on a third interface different from the first interface and that overlaps a part of the second internal electrode and a part of the third internal electrode when viewed in the third direction, a first external electrode, a second external electrode, and a third external electrode. The fourth internal electrode and the fifth internal electrode do not overlap each other when viewed in the third direction.

### TECHNICAL FIELD

The present disclosure relates to a layered varistor, and particularly to a layered varistor including a sintered body, internal electrodes, and external electrodes.

### BACKGROUND ART

A layered varistor is used for purposes of protecting various electronic apparatuses and electronic devices from abnormal voltage caused by lightening surge, or static electricity, and preventing malfunction of electronic apparatuses and electronic devices caused by noise generated in a circuit.

A layered varistor having a 2-in-1 structure in which two varistor elements are formed in one layered varistor has been proposed. PTLS 1 and 2 are known as prior art related to the present disclosure.

### CITATION LIST

### Patent Literature

PTL 1: Japanese Patent Laid-Open Publication No. 01-66907

PTL 2: Japanese Patent Laid-Open Publication No. 2022-541973

### SUMMARY OF INVENTION

In the manufacture of a layered varistor having a conventional 2-in-1 structure, variation in dimensions, shapes, and positions of an internal electrode and an external electrode are unavoidable. The varistor thus provides a disadvantage that capacitance is different two varistor elements. When the capacitance between the two varistor elements are greatly different, crosstalk tends to occur, in which signals leak from one terminal to the other.

A layered varistor according to an aspect of the present disclosure includes a sintered body, a first internal electrode, a second internal electrode, a third internal electrode, a fourth internal electrode, a fifth internal electrode, a first external electrode, a second external electrode, and a third external electrode. The sintered body has a rectangular parallelepiped shape having a first end surface, a second end surface opposite to the first end surface in a first direction, a first side surface, a second side surface opposite to the first side surface in a second direction, a first main surface, and a second main surface opposite to the first main surface in a third direction. The sintered body has a layered structure including plural layers stacked on one another in the third direction. The first internal electrode, the second internal electrode, and the third internal electrode are disposed on a first interface and inside the sintered body, and do not contact one another. The fourth internal electrode is disposed on a second interface different from the first interface and inside the sintered body, and overlaps a part of the first internal electrode and a part of the third internal electrode when viewed in the third direction. The fifth internal electrode is disposed on a third interface different from the first interface and inside the sintered boy, and overlaps a part of the second internal electrode and a part of the third internal electrode when viewed in the third direction. The first external electrode is disposed on at least one of the first end surface, the first side surface, and is the second side surface, and electrically connected to the first internal electrode. The second external electrode is disposed on at least one of the second end surface, the first side surface, and the second side surface, and is electrically connected to the second internal electrode. The third external electrode is disposed on at least one of the first side surface and the second side surface, and is electrically connected to the third internal electrode. The fourth internal electrode and the fifth internal electrode do not overlap each other when viewed in the third direction.

The present disclosure advantageously reduces a capacitance difference between two varistor elements caused by variation in, e.g., dimensions, and reduces the occurrence of crosstalk.

### BRIEF DESCRIPTION OF DRAWINGS

FIG. 1A is a sectional view of a layered varistor viewed in a third direction according to an exemplary embodiment of the present disclosure.

FIG. 1B is a sectional view of the layered varistor viewed in a second direction according to the embodiment of the present disclosure.

FIG. 1C is a perspective view of the layered varistor according to the embodiment of the present disclosure.

FIG. 2 is a sectional view of the layered varistor viewed in the second direction according to the embodiment of the present disclosure.

FIG. 3A is a sectional view of the layered varistor viewed in the third direction according to the embodiment of the present disclosure.

FIG. 3B is a sectional view of the layered varistor viewed in the third direction according to the embodiment.

FIG. 4A is a sectional view of a layered varistor viewed in the third direction according to another exemplary embodiment of the present disclosure.

FIG. 4B is a sectional view of a layered varistor viewed in the third direction according to still another exemplary embodiment of the present disclosure.

FIG. 5 is a sectional view of the layered varistor viewed in the second direction according to the embodiment of the present disclosure.

FIG. 6 is a sectional view of the layered varistor viewed in the third direction according to the embodiment of the present disclosure.

FIG. 7 is a sectional view of the layered varistor viewed in the third direction according to the embodiment of the present disclosure.

FIG. 8 is a sectional view of the layered varistor viewed in the second direction according to the embodiment of the present disclosure.

FIG. 9 is a sectional view of the layered varistor viewed in the second direction according to the embodiment of the present disclosure.

FIG. 10A is a perspective view of the layered varistor viewed in the third direction according to the embodiment of the present disclosure.

FIG. 10B is a perspective view of the layered varistor viewed in the second direction according to the exemplary embodiment of the present disclosure.

FIG. 11A is a perspective view of the layered varistor viewed in the third direction according to the embodiment of the present disclosure.

FIG. 11B is a perspective view of the layered varistor viewed in the second direction according to the embodiment of the present disclosure.

FIG. 12A is a perspective view of the layered varistor viewed in the third direction according to the embodiment of the present disclosure.

FIG. 12B is a perspective view of the layered varistor viewed in the second direction according to the embodiment of the present disclosure.

FIG. 13A is a sectional view of a layered varistor viewed in the second direction according to still another exemplary embodiment of the present disclosure.

FIG. 13B is a sectional view of a layered varistor viewed in the second direction according to still another exemplary embodiment of the present disclosure.

FIG. 13C is a sectional view of a layered varistor viewed in the second direction according to still another exemplary embodiment of the present disclosure.

FIG. 14A is a sectional view of a layered varistor viewed in the second direction according to an example of the present disclosure.

FIG. 14B is a sectional view of a layered varistor viewed in the second direction according to still another example of the present disclosure.

### DESCRIPTION OF EMBODIMENT

### 1. Outline

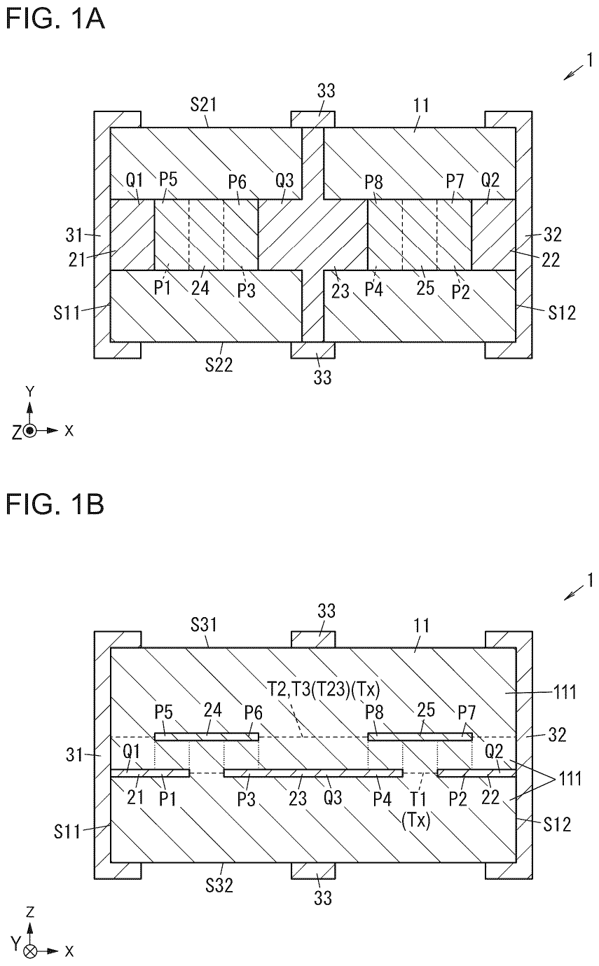

An outline of layered varistor 1 will be described below with reference to FIGS. 1A, 1B, and 1C. Note that the drawings referred to in the following exemplary embodiments are illustrative, and size and thickness ratios of components therein may not reflect actual dimensional ratios.

After earnest study on a layered varistor having a 2-in-1 structure in order to solve the aforementioned disadvantage, a certain arrangement pattern of internal electrodes is found to reduce a difference in two capacitances of the layered varistor, and resulted in the present disclosure.

Layered varistor 1 includes sintered body 11, first internal electrode 21, second internal electrode 22, third internal electrode 23, fourth internal electrode 24, fifth internal electrode 25, first external electrode 31, second external electrode 32, and third external electrode 33.

First internal electrode 21, second internal electrode 22, and third internal electrode 23 are disposed on first interface T1 and inside sintered body 11, and are spaced apart from one another and do not contact one another.

Fourth internal electrode 24 is disposed on second interface T2 different from first interface T1 and inside sintered body 11, and overlaps a part of first internal electrode 21 and a part of third internal electrode 23 when viewed in a third direction (Z direction).

Fifth internal electrode 25 is disposed on third interface T3 different from first interface T1 and inside sintered body 11, and overlaps a part of second internal electrode 22 and a part of third internal electrode 23 when viewed in the third direction (Z direction).

Fourth internal electrode 24 and fifth internal electrode 25 do not overlap each other when viewed in the third direction (Z direction).

In layered varistor 1 according to the embodiment, first internal electrode 21, third internal electrode 23, and internal electrode 24 constitute a first varistor element while second internal electrode 22, third internal electrode 23, and fifth internal electrode 25 constitute a second varistor element. In the first varistor element, a surge current flows when a surge voltage is applied between first internal electrode 21 and third internal electrode 23. In the second varistor element, a surge current flows when a surge voltage is applied between second internal electrode 22 and third internal electrode 23.

In layered varistor 1 according to the above exemplary embodiment, first internal electrode 21, second internal electrode 22, and third internal electrode 23 are disposed on the same first interface T1, and fourth internal electrode 24 and fifth internal electrode 25 are disposed on second interface T2 and third interface T3 that are different from first interface T1, so as to configure facing surfaces. As a result, layered varistor 1 has a structure including two varistor elements formed therein. First internal electrode 21, second internal electrode 22, and third internal electrode 23 are disposed on the same first interface T1, and are displace in the same direction even when layer displacement occurs due to variation in dimensions, shapes, and positions of internal electrodes and external electrodes formed during manufacturing layered varistor 1. This configuration suppresses a difference in facing areas configuring the two varistor elements. For this reason, layered varistor 1 reduces a capacitance difference between two varistor elements caused by variation in, e.g., dimensions, and therefore reduces the occurrence of crosstalk.

### 2. Details

### Layered Varistor

Layered varistor 1 according to first to fourth exemplary embodiments will be detailed below.

### First Exemplary Embodiment

As described above, layered varistor 1 according to the first exemplary embodiment has the following configuration.

Layered varistor 1 includes sintered body 11, internal electrodes, and external electrodes. The internal electrodes are first internal electrode 21, second internal electrode 22, third internal electrode 23, fourth internal electrode 24, and fifth internal electrode 25. The external electrodes are first external electrode 31, second external electrode 32, and third external electrode 33.

First internal electrodes 21, second internal electrodes 22, and third internal electrodes 23 are disposed on first interface T1, and do not contact one another.

Fourth internal electrode 24 is disposed on second interface T2, and overlaps a part of first internal electrode 21 and a part of third internal electrode 23 when viewed in a third direction (Z direction).

Fifth internal electrode 25 is disposed on third interface T3, and overlaps a part of second internal electrode 22 and a part of third internal electrode 23 when viewed in the third direction (Z direction).

Fourth internal electrode 24 and fifth internal electrode 25 do not overlap each other when viewed in the third direction (Z direction).

In the description, “overlap” means that at least a part of two objects (e.g., internal electrodes) intersect when viewed in one direction (e.g., third direction).

Each component of layered varistor 1 will be described below.

### Sintered Body

Sintered body 11 has a layered structure including multiple layers 111 stacked on one another in the third direction (Z direction) via plural interfaces Tx. In accordance with the present embodiment, sintered body 11 has a rectangular parallelepiped shape with a longer side with length in a first direction (X direction) ranging from 0.5 mm to 3 mm, a width ranging from 0.3 mm to 2 mm, and a height ranging from 0.3 mm to 2 mm. In other words, in sintered body 11, four sides extending in the first direction are longer than four sides extending in a second direction and four sides extending in the third direction. Sides of the rectangular parallelepiped sintered body 11 may be chamfered or the sides of sintered body 11 may be rounded as appropriate.

Sintered body 11 is made of, for example, semiconductor ceramic component having nonlinear resistance characteristic. As the semiconductor ceramic component, sintered body 11 contains ZnO as a main component, and may further contain at least one of Bi₂O₃, Pr₆O₁₁, CaCO₃, Co₂O₃, Cr₂O₃, MnO₂, and Sb₂O₃ as a sub-component. In sintered body 11, ZnO is sintered and at least a part of other sub-components is precipitated in a grain boundary. A nonlinear resistance characteristic appears by a boundary barrier formed between ZnO particles. Sintered body 11 is formed by sintering plural layers containing ZnO as the main component stacked on one another in the third direction (Z direction).

Sintered body 11 has first end surface S11, second end surface S12 opposite to first end surface S11 in the first direction (X direction), first side surface S21, second side surface S22 opposite to first side surface S21 in the second direction (Y direction), first main surface S31, and second main surface S32 opposite to first main surface S31 in the third direction (Z direction).

### Internal Electrode

Layered varistor 1 includes first internal electrode 21, second internal electrode 22, third internal electrode 23, fourth internal electrode 24, and fifth internal electrode 25 as the internal electrodes.

As illustrated in FIGS. 1A and 1B, first internal electrode 21, second internal electrode 22, and third internal electrode 23 are disposed on first interface T1. First internal electrode 21, second internal electrode 22, and third internal electrode 23 are spaced apart from one another and do not contact one another.

Fourth internal electrode 24 is disposed on second interface T2 different from first interface T1. Fourth internal electrode 24 overlaps a part of first internal electrode 21 and a part of third internal electrode 23 when viewed in the third direction (Z direction).

Fifth internal electrode 25 is disposed on third interface T3 different from first interface T1. Fifth internal electrode 25 overlaps a part of second internal electrode 22 and a part of third internal electrode 23 when viewed in the third direction (Z direction).

Fourth internal electrode 24 and fifth internal electrode 25 do not overlap each other when viewed in the third direction (Z direction).

Internal electrodes 21 to 25 has flat plate shapes with, e.g., a length and width of 0.05 mm or more and 3 mm or less and a thickness of 0.5 μm or more and 5 μm or less. Regarding the shapes of the internal electrodes in plan view, for example, each of first internal electrode 21 and second internal electrode 22 has a rectangular shape, a square shape, or a T-shape. Third internal electrode 23 has a cross shape. Each of fourth internal electrode 24 and fifth internal electrode 25 has a rectangular shape, a square shape, or an array shape.

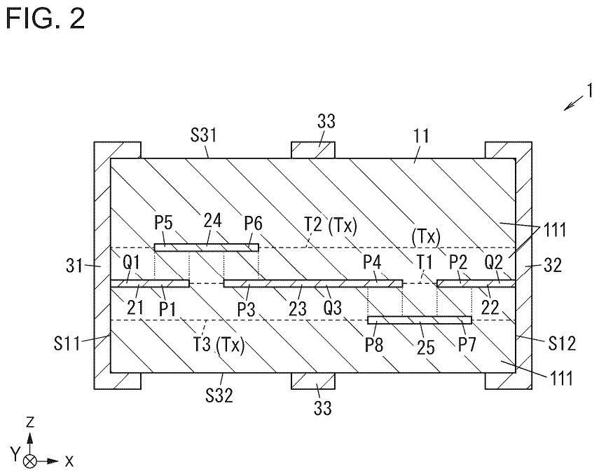

In FIG. 1A, a width of the first to third internal electrodes (length in the second direction (Y direction)) and a width of the fourth and fifth internal electrodes are the same. However, these widths may differ as illustrated in FIGS. 3A and 3B.

Internal electrodes 21 to 25 may contain, for example, Pd, Pt, Ag, or Au.

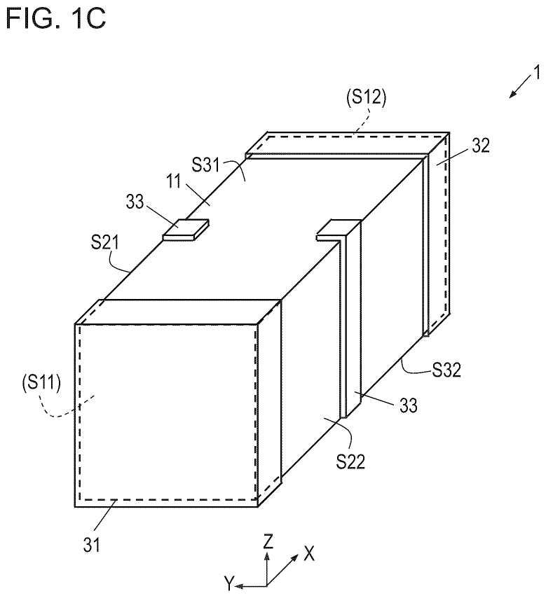

Second interface T2 on which fourth internal electrode 24 is disposed and third interface T3 on which fifth internal electrode 25 is disposed may be same interface T23 as illustrated in FIG. 1B, or different interfaces as illustrated in FIG. 2. Fourth internal electrode 24 and fifth internal electrode 25 disposed on same interface T23 are displaced in the same way even when layer displacement occurs. This configuration suppresses a change in facing areas of two varistor elements, resultantly reducing a capacitance difference between the two varistor elements and reducing the occurrence of crosstalk. Fourth internal electrode 24 and fifth internal electrode 25 on the different interfaces increase a distance between fourth internal electrode 24 and fifth internal electrode 25, resultantly reducing the occurrence of crosstalk.

Thus, a change in facing areas of two varistor elements can be suppressed.

### External Electrode

Layered varistor 1 includes first external electrode 31, second external electrode 32, and third external electrode 33 as the external electrodes.

First external electrode 31 is disposed on at least one of first end surface S11, first side surface S21, and second side surface S22. First external electrode 31 is electrically connected to first internal electrode 21.

Second external electrode 32 is disposed on at least one of second end surface S12, first side surface S21, and second side surface S22. Second external electrode 32 is electrically connected to second internal electrode 22.

Third external electrode 33 is disposed on at least one of first side surface S21 and second side surface S22. Third external electrode 33 is electrically connected to third internal electrode 23.

External electrodes 31 to 33 contain metal and may further contain glass component. Examples of the metal include Ag, Pd, Pt, Au, and Cu. The electrodes may preferably contain Ag. The glass component refers to an amorphous substance having a softening point. Examples of the glass component include silica glass and zinc borosilicate glass.

First external electrode 31 and second external electrode 32 may be formed on first end surface S11 and second end surface S12 of sintered body 11, respectively, by, e.g., dipping the surfaces in conductive paste. Third external electrode 33 may be formed by, e.g., performing a roller transfer of conductive paste on the surface of sintered body 11.

### Plated Electrode

Layered varistor 1 may include plated electrodes covering at least respective parts of first external electrode 31, second external electrode 32, and third external electrode 33. The plated electrodes may be formed by, for example, an electroplating method to perform Ni plating or Ni plating and then Sn plating on the parts of the surfaces of external electrodes 31 to 33.

As illustrated in FIG. 3A, length Y1 of fourth internal electrode 24 in the second direction (Y direction) is preferably larger than length X1 of first internal electrode 21 in the second direction (Y direction). Length Y1 of fifth internal electrode 25 in the second direction (Y direction) is preferably larger than length X1 of second internal electrode 22 in the second direction (Y direction). This configuration suppresses a change in facing areas of two varistor elements even when layer displacement occurs or an angle between first interface T1 and one of second interface T2 and third interface T3 deviates. As a result, a capacitance difference is reduced, and the occurrence of crosstalk is reduced.

As illustrated in FIG. 3B, length Y1 of fourth internal electrode 24 in the second direction (Y direction) is preferably smaller than length X1 of first internal electrode in the second direction (Y direction). Length Y1 of fifth internal electrode 25 in the second direction (Y direction) is preferably smaller than length X1 of second internal electrode 22 in the second direction (Y direction). This configuration suppresses a change in facing areas of two varistor elements even when layer displacement occurs or an angle between first interface T1 and one of second interface T2 or third interface T3 deviates. As a result, a capacitance difference is reduced, and the occurrence of crosstalk is reduced.

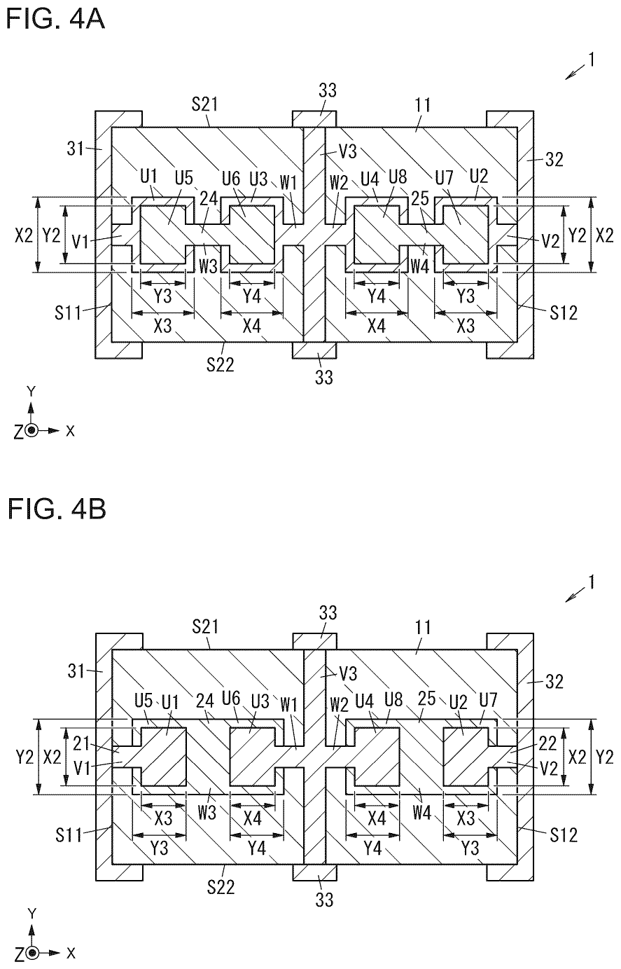

As illustrated in FIG. 5, distance B1 between first internal electrode 21 and third internal electrode 23 in the first direction (X direction) is preferably larger than distance A1 between first interface and second interface T2 in the third direction (Z direction). Distance B1 between second internal electrode 22 and third internal electrode 23 in the first direction (X direction) is preferably larger than distance A1 between first interface T1 and second interface T2 in the third direction (Z direction). A larger distance between third internal electrode 23 and one of first internal electrode 21 or second internal electrode 22 than a distance between the interfaces reduces a capacitance difference while maintaining various performances of layered varistor 1, and further reduces the occurrence of crosstalk.

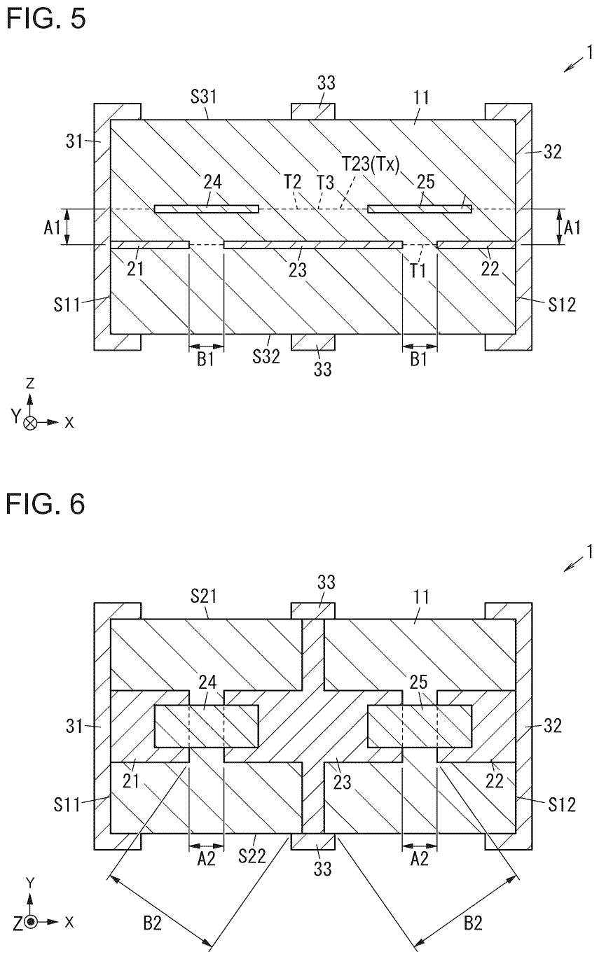

As illustrated in FIG. 6, shortest distance B2 between first internal electrode 21 and third external electrode 33 is preferably larger than shortest distance A2 between first internal electrode 21 and third internal electrode 23. Shortest distance B2 between second internal electrode 22 and third external electrode 33 is preferably larger than shortest distance A2 between second internal electrode 22 and third internal electrode 23. A larger distance between third external electrode 33 and one of internal electrode 21 or second internal electrode 22 than the distance between third internal electrode 23 and one of first internal electrode 21 or second internal electrode 22 where a potential difference is generated between the electrodes reduces a capacitance difference, and reduces the occurrence of crosstalk. The “shortest distance” between the electrodes refer to the shortest distance among lengths between every point on one electrode and every point on another electrode.

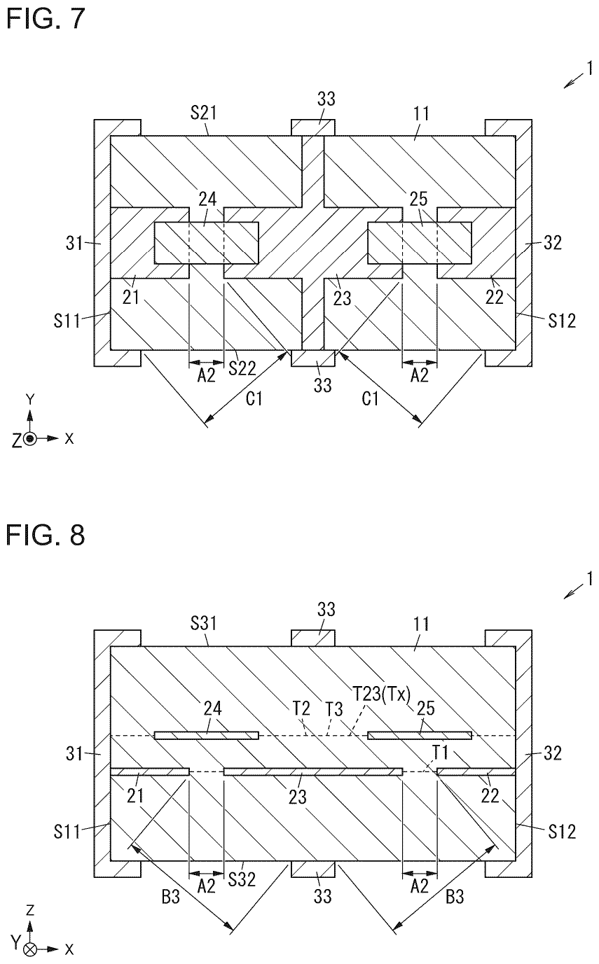

As illustrated in FIG. 7, shortest distance C1 between third internal electrode 23 and first external electrode 31 is preferably larger than shortest distance A2 between first internal electrode 21 and third internal electrode 23. Shortest distance C1 between third internal electrode 23 and second external electrode 32 is preferably larger than shortest distance A2 between second internal electrode 22 and third internal electrode 23. A larger distance between third internal electrode 23 and one of first external electrode 31 or second external electrode 32 where a potential difference is generated between the electrodes than the distance between third internal electrode 23 and one of first internal electrode 21 or second internal electrode 22 further reduces a capacitance difference, and further reduces the occurrence of crosstalk.

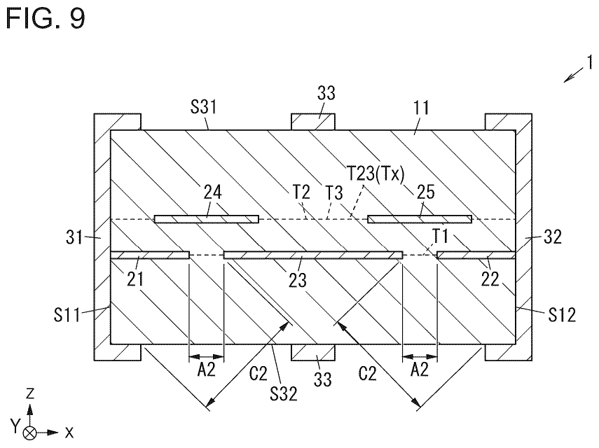

As illustrated in FIG. 8, shortest distance B3 between first internal electrode 21 and third external electrode 33 is preferably larger than shortest distance A2 between first internal electrode 21 and third internal electrode 23. Shortest distance B3 between second internal electrode 22 and third external electrode 33 is preferably larger than shortest distance A2 between second internal electrode 22 and third internal electrode 23. A larger distance between third external electrode 33 and one of first internal electrode 21 or second internal electrode 22, where a potential difference is generated between the electrodes, than a distance between third internal electrode 23 and one of first internal electrode 21 or second internal electrode 22 reduces a capacitance difference, and further reduces the occurrence of crosstalk.

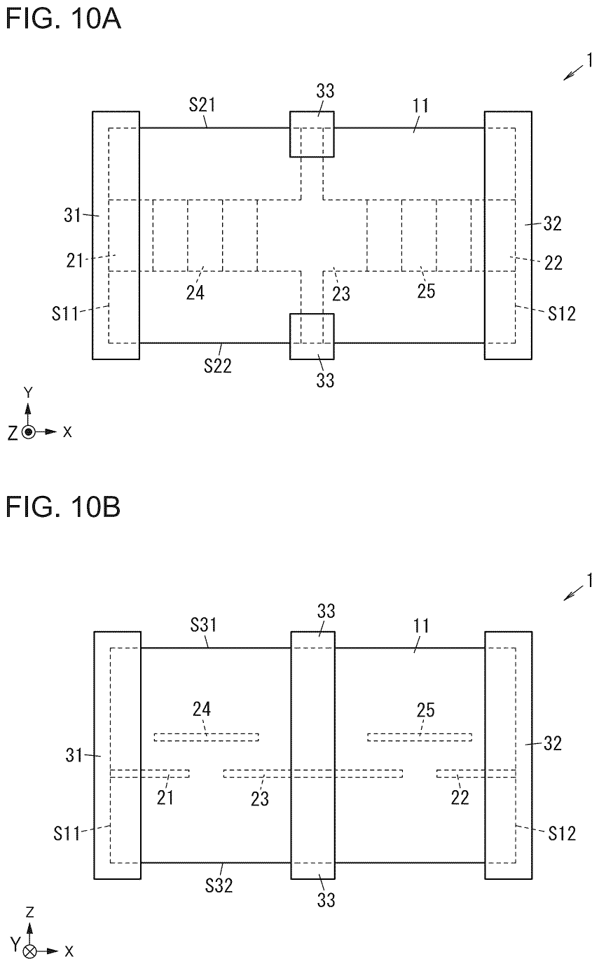

As illustrated in FIG. 9, shortest distance C2 between third internal electrode 23 and first external electrode 31 is preferably larger than shortest distance A2 between first internal electrode 21 and third internal electrode 23. Shortest distance C2 between third internal electrode 23 and second external electrode 32 is preferably larger than shortest distance A2 between second internal electrode 22 and third internal electrode 23. A larger distance between third internal electrode 23 and one of first external electrode 31 or second external electrode 32, where a potential difference is generated between the electrodes, than the distance between third internal electrode 23 and one of first internal electrode 21 or second internal electrode 22 reduces a capacitance difference, and further reduces the occurrence of crosstalk.

### External Electrode

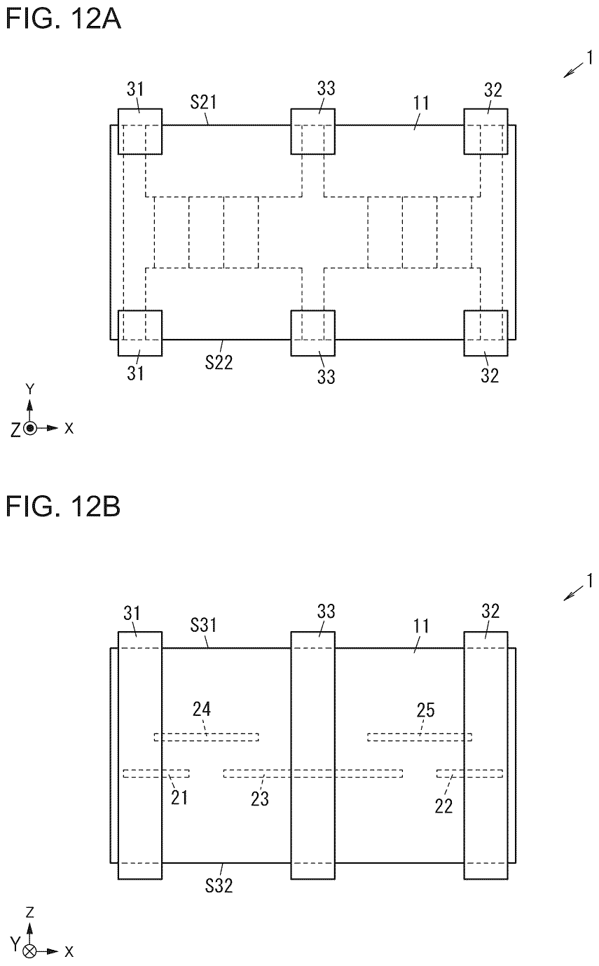

As illustrated in FIGS. 11A and 11B, third external electrode 33 preferably does not overlap fourth internal electrode 24 and fifth internal electrode 25 when viewed in the third direction (Z direction) and also in the second direction (Y direction). A large distance from third external electrode 33 to fourth internal electrode 24 and fifth internal electrode 25 further reduces a capacitance difference, and further reduces the occurrence of crosstalk.

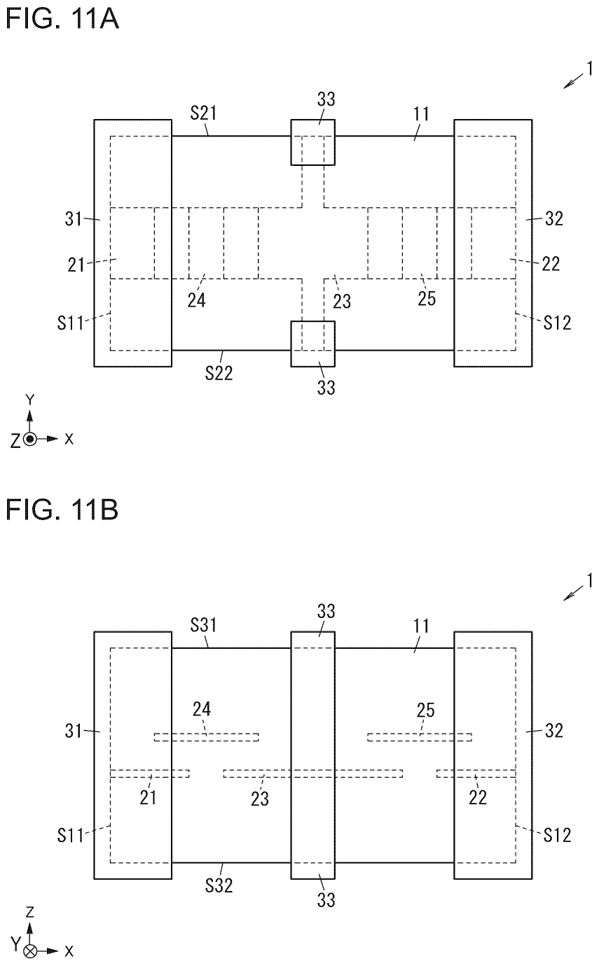

As illustrated in FIGS. 10A and 10B, first external electrode 31 and second external electrode 32 preferably do not overlap fourth internal electrode 24 and fifth internal electrode 25 when viewed in the third direction (Z direction) and also in the second direction (Y direction). A large distance from first external electrode 31 and second external electrode 32 to fourth internal electrode 24 and fifth internal electrode 25 reduces a capacitance difference, and further reduces the occurrence of crosstalk.

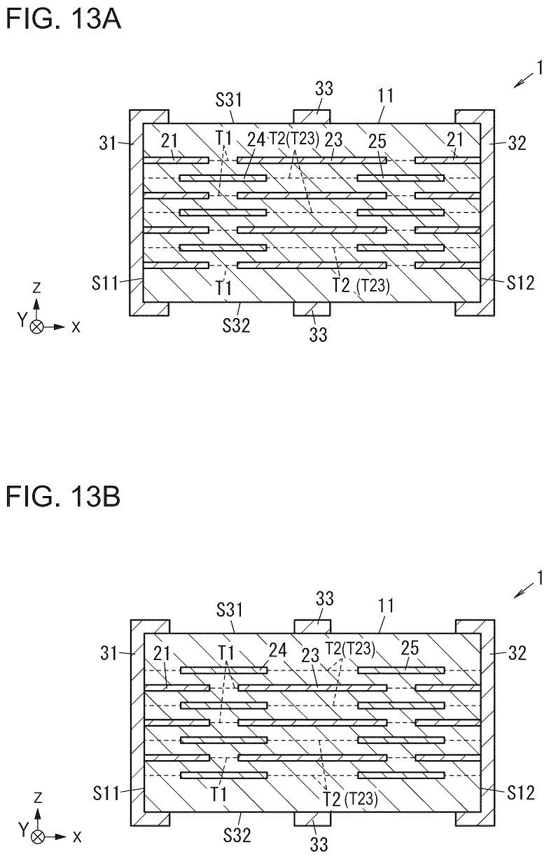

As illustrated in FIGS. 12A and 12B, first external electrode 31 and second external electrode 32 are preferably disposed on at least one of first side surface S21 and second side surface S22. Even in this arrangement of third external electrode 33, a large distance from third external electrode 33 to fourth internal electrode 24 and fifth internal electrode 25 further reduces a capacitance difference, and further reduces the occurrence of crosstalk by

### Second Exemplary Embodiment

In layered varistor 1 according to a second exemplary embodiment, first to fifth internal electrodes 21 to 25 are configured as described below in addition to the configuration of layered varistor 1 according to the first exemplary embodiment described above.

First internal electrode 21 includes first overlap P1 and first connection Q1. First overlap P1 overlaps fourth internal electrode 24 when viewed in the third direction (Z direction). First connection Q1 connects first overlap P1 to first external electrode 31.

Second internal electrode 22 includes second overlap P2 and second connection Q2. Second overlap P2 overlaps fifth internal electrode 25 when viewed in the third direction (Z direction). Second connection Q2 connects second overlap P2 to second external electrode 32.

Third internal electrode 23 includes third overlap P3, fourth overlap P4, and third connection Q3. Third overlap P3 overlaps fourth internal electrode 24 when viewed in the third direction (Z direction). Fourth overlap P4 overlaps fifth internal electrode 25 when viewed in the third direction (Z direction). Third connection Q3 connects third overlap P3 and fourth overlap P4 to third external electrode 33.

Fourth internal electrode 24 includes fifth overlap P5 and sixth overlap P6. Fifth overlap P5 faces first overlap P1 when viewed in the third direction (Z direction). Sixth overlap P6 faces third overlap P3 when viewed in the third direction (Z direction).

Fifth internal electrode 25 includes seventh overlap P7 and eighth overlap P8. Seventh overlap P7 faces second overlap P2 when viewed in the third direction (Z direction). Eighth overlap P8 faces fourth overlap P4 when viewed in the third direction (Z direction).

In the description, “overlap” means that a portion of one internal electrode overlaps another internal electrode in the third direction (Z direction).

The above configuration of layered varistor 1 according to the second exemplary embodiment reduces a capacitance difference, and reduces the occurrence of crosstalk.

As illustrated in FIG. 3A, length Y1 of fourth internal electrode 24 in the second direction (Y direction) is preferably larger than length Z1 of third overlap P3 of third internal electrode 23 in the second direction (Y direction). Length Y1 of fifth internal electrode 25 in the second direction (Y direction) is preferably larger than length Z1 of fourth overlap P4 of third internal electrode 23 in the second direction (Y direction). This configuration suppresses, even when layer displacement occurs or even when an angle between first interface T1 and one of second interface T2 or third interface T3 deviates, a change in facing areas of the two varistor elements, resultantly, reducing a capacitance difference and reducing the occurrence of crosstalk.

As illustrated in FIG. 3B, length Y1 of fourth internal electrode 24 in the second direction (Y direction) is preferably smaller than length Z1 of third overlap P3 of third internal electrode 23 in the second direction (Y direction). Length Y1 of fifth internal electrode 25 in the second direction (Y direction) is also preferably smaller than length Z1 of fourth overlap P4 of third internal electrode 23 in the second direction (Y direction). This configuration suppresses, even when layer displacement occurs or even when an angle between first interface T1 and second interface T2 or third interface T3 deviates, a change in facing areas of the two varistor elements, resultantly, reducing a capacitance difference and reducing the occurrence of crosstalk.

### Third Exemplary Embodiment

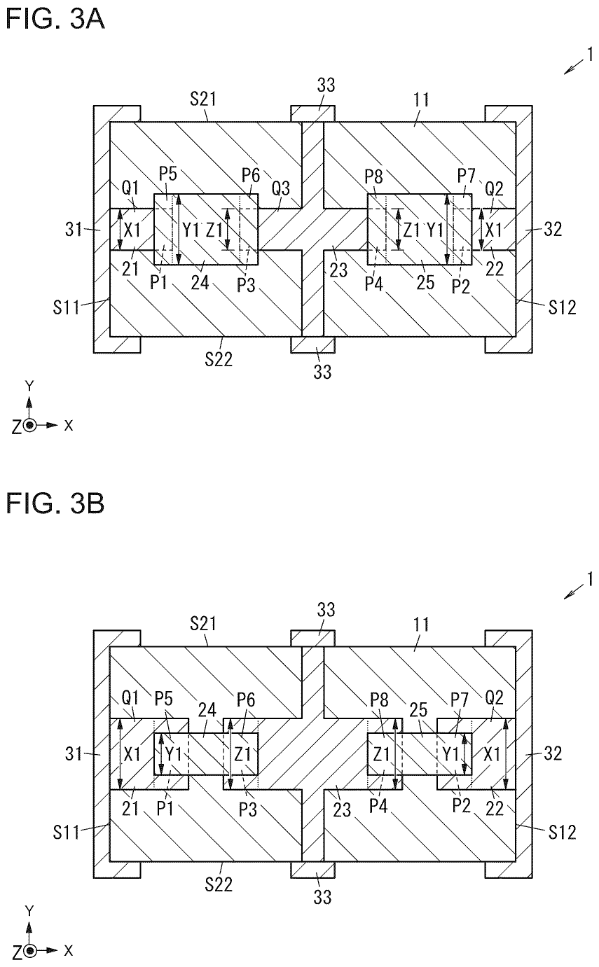

In layered varistor 1 according to a third exemplary embodiment, as illustrated in FIGS. 4A and 4B, first to fifth internal electrodes 21 to 25 have a configuration described below in addition to the configuration of layered varistor 1 according to the first exemplary embodiment described above.

First internal electrode 21 includes first facing part U1 and first lead-out part V1. Facing part U1 faces fourth internal electrode 24 in the third direction (Z direction). First lead-out part V1 connects first facing part U1 to first external electrode 31. A length of first lead-out part V1 in the second direction (Y direction) is smaller than a length of first facing part U1 in the second direction (Y direction).

Second internal electrode 22 includes second facing part U2 and second lead-out part V2. Second facing part U2 faces fifth internal electrode 25 in the third direction (Z direction). Second lead-out part V2 connects second facing part U2 to second external electrode 32. A length of second lead-out part V2 in the second direction (Y direction) is smaller than a length of second facing part U2 in the second direction (Y direction).

Third internal electrode 23 includes third facing part U3, first joint W1, fourth facing part U4, second joint W2, and third lead-out part V3. Third facing part U3 faces fourth internal electrode 24 in the third direction (Z direction). A length of first joint W1 in the second direction (Y direction) is smaller than a length of third facing part U3 in the second direction (Y direction). Fourth facing part U4 faces fifth internal electrode 25 in the third direction (Z direction). A length of second joint W2 in the second direction (Y direction) is smaller than a length of fourth facing part U4 in the second direction (Y direction). Third lead-out part V3 that first joint W1 and second joint W2 to third external electrode 33.

Fourth internal electrode 24 includes fifth facing part U5, sixth facing part U6, and third joint W3. Fifth facing part U5 faces first facing part U1 in the third direction (Z direction). Sixth facing part U6 faces third facing part U3 in the third direction (Z direction). Third joint W3 connects fifth facing part U5 to sixth facing part U6.

Fifth internal electrode 25 includes seventh facing part U7, eighth facing part U8, and fourth joint W4. Seventh facing part U7 faces second facing part U2 in the third direction (Z direction). Eighth facing part U8 faces fourth facing part U4 in the third direction (Z direction). Fourth joint W4 connects seventh facing part U7 to eighth facing part U8.

In the description, “facing part” means a portion, other than the lead-out part and joint, in one internal electrode that faces another internal electrode.

In layered varistor 1 according to the third exemplary embodiment, a width of first lead-out part V1 that connects first facing part U1 of first internal electrode 21 to first external electrode 31 is reduced. A width of second lead-out part V2 that connects second facing part U2 of second internal electrode 22 to second external electrode 32 is reduced. Widths of first joint W1 and second joint W2 that connect third facing part U3 and fourth facing part U4 to third lead-out part V3 of third internal electrode 23 are reduced. This configuration suppresses, even when layer displacement occurs due to variation in dimensions, a change in facing areas of the two varistor elements, resultantly reducing a capacitance difference and reducing the occurrence of crosstalk.

As illustrated in FIG. 4A, length Y3 of fifth facing part U5 of fourth internal electrode 24 in the first direction (X direction) is preferably smaller than length X3 of first facing part U1 of first internal electrode 21 in the first direction (X direction). Length Y3 of seventh facing part U7 of fifth internal electrode 25 in the first direction (X direction) is preferably smaller than length X3 of second facing part U2 of second internal electrode 22 in the first direction (X direction). This configuration suppresses, even when layer displacement occurs or even when an angle between first interface T1 and one of second interface T2 or third interface T3 deviates, a change in facing areas of the two varistor elements, resultantly reducing a capacitance difference and reducing the occurrence of crosstalk.

Length Y4 of sixth facing part U6 of fourth internal electrode 24 in the first direction (X direction) is preferably smaller than length X4 of third facing part U3 of third internal electrode 23 in the first direction (X direction). Length Y4 of eighth facing part U8 of fifth internal electrode 25 in the first direction (X direction) is preferably smaller than length X4 of fourth facing part U4 of third internal electrode 23 in the first direction (X direction). This configuration suppresses, even when layer displacement occurs or an angle between first interface T1 and one of second interface T2 or third interface T3 deviates, a change in facing areas of the two varistor elements, resultantly reducing a capacitance difference and reducing the occurrence of crosstalk.

As illustrated in FIG. 4B, length Y3 of fifth facing part U5 of fourth internal electrode 24 in the first direction (X direction) is preferably larger than length X3 of first facing part U1 of first internal electrode 21 in the first direction (X direction). Length Y3 of seventh facing part U7 of fifth internal electrode 25 in the first direction (X direction) is preferably larger than length X3 of facing part U2 of second internal electrode 22 in the first direction (X direction). This configuration suppresses, even when layer displacement occurs or an angle between first interface T1 and one of second interface T2 or third interface T3 deviates, a change in facing areas of the two varistor elements, resultantly reducing a capacitance difference and reducing the occurrence of crosstalk.

Length Y4 of sixth facing part U6 of fourth internal electrode 24 in the first direction (X direction) is preferably larger than length X4 of third facing part U3 of third internal electrode 23 in the first direction (X direction). Length Y4 of eighth facing part U8 of fifth internal electrode 25 in the first direction (X direction) is preferably larger than length X4 of fourth facing part U4 of third internal electrode 23 in the first direction (X direction). This configuration suppresses, even when layer displacement occurs or an angle between first interface T1 and one of second interface T2 or third interface T3 deviates, a change in facing areas of the two varistor elements, resultantly reducing a capacitance difference and reducing the occurrence of crosstalk.

As illustrated in 4A, length Y2 of fifth facing part U5 of fourth internal electrode 24 in the second direction (Y direction) is preferably smaller than length X2 of first facing part U1 of first internal electrode 21 in the second direction (Y direction). Length Y2 of seventh facing part U7 of fifth internal electrode 25 in the second direction (Y direction) is preferably smaller than length X2 of second facing part U2 of second internal electrode 22 in the second direction (Y direction). This configuration suppresses, even when layer displacement occurs or an angle between first interface T1 and one of second interface T2 or third interface T3 deviates, a change in facing areas of the two varistor elements, resultantly reducing a capacitance difference and reducing the occurrence of crosstalk.

As illustrated in FIG. 4B, length Y2 of fifth facing part U5 of fourth internal electrode 24 in the second direction (Y direction) is preferably larger than length X2 of first facing part U1 of first internal electrode in the second direction (Y direction). Length Y2 of seventh facing part U7 of fifth internal electrode 25 in the second direction (Y direction) is preferably larger than length X2 of second facing part U2 of second internal electrode 22 in the second direction (Y direction). This configuration suppresses, even when layer displacement occurs or an angle between first interface T1 and one of second interface T2 or third interface T3 deviates, a change in facing areas of the two varistor elements, resultantly, reducing a capacitance difference and reducing the occurrence of crosstalk.

As illustrated in FIG. 4A, a length of third joint W3 of fourth internal electrode 24 in the second direction (Y direction) is preferably smaller than a length of fifth facing part U5 of fourth internal electrode 24 in the second direction (Y direction) and a length of sixth facing part U6 of fourth internal electrode 24 in the second direction (Y direction). A length of fourth joint W4 of fifth internal electrode 25 in the second direction (Y direction) is preferably smaller than a length of seventh facing part U7 of fifth internal electrode 25 and a length of eighth facing part U8 of fifth internal electrode 25 in the second direction (Y direction). This configuration suppresses, even when layer displacement occurs in the first direction (X direction) or an angle between first interface T1 and one of second interface T2 or third interface T3 deviates, a change in facing areas, resultantly reducing a capacitance difference and reducing the occurrence of crosstalk.

### Fourth Exemplary Embodiment

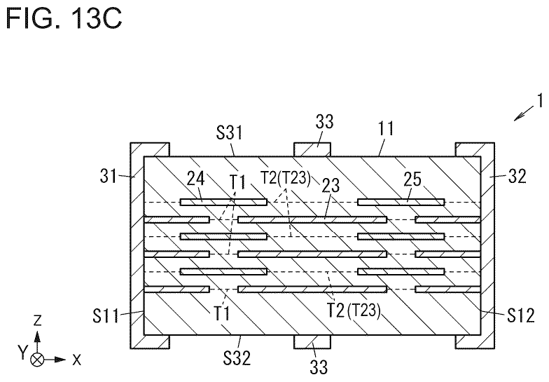

Layered varistor 1 according to a fourth exemplary embodiment includes plural first internal electrodes 21, plural second internal electrodes 22, plural third internal electrodes 23, plural fourth internal electrodes 24, and plural fifth internal electrodes 25, as illustrated in FIGS. 13A to 13C.

Since layered varistor 1 according to the fourth exemplary embodiment including plural first internal electrodes 21, plural second internal electrodes 22, plural third internal electrodes 23, plural fourth internal electrodes 24, and plural fifth internal electrodes 25 improves various performances of layered varistor 1 while providing an effect of reducing a capacitance difference smaller, thereby reducing the occurrence of crosstalk.

In layered varistor 1 according to the fourth exemplary embodiment, second interface T2 and third interface T3 are same interface T23. First interfaces T1 and same interfaces T23 each of which is second interface T2 and third interface T3 are alternately arranged.

In layered varistor 1 illustrated in FIG. 13A, one of two of first interfaces T1 is disposed closest to first main surface S31 in the third direction (Z direction) and anther of the two of first interfaces T1 is closest to second main surface S32 in the third direction (Z direction). In this case, the first to third internal electrodes (21 to 23) are disposed on the outermost sides, thus maximizing the effect of reducing a capacitance difference and crosstalk.

In layered varistor 1 illustrated in FIG. 13C, one of first interfaces T1 is closest to second main surface S32 in the third direction (Z direction), and one of same interfaces T23 is closest to first main surface S31. Similarly, one of first interfaces T1 may be closest to first main surface S31 in the third direction (Z direction), and one of same interfaces T23 may be closest to second main surface S32. In this case, one of first interfaces T1 including the first to third internal electrodes (21 to 23) is closest to first main surface S31 or second main surface S32, thereby enhancing the effect of reducing a capacitance difference and crosstalk.

In layered varistor 1 illustrated in FIG. 13B, one of the same interfaces T23 (second interface T2 and third interface T3) is closest to first main surface S31 in the third direction (Z direction), and another of the same interfaces T23 is closest to second main surface S32 in the third direction (Z direction). This configuration enhances the effect of reducing a capacitance difference and crosstalk.

### 3. Aspects

As it is apparent from the above exemplary embodiments, the present disclosure includes the following aspects.

A layered varistor (1) according to a first aspect includes a sintered body (11), a first internal electrode (21), a second internal electrode (22), a third internal electrode (23), a fourth internal electrode (24), a fifth internal electrode (25), a first external electrode (31), a second external electrode (32), and a third external electrode (33). The sintered body (11) has a rectangular parallelepiped shape having a first end surface (S11), a second end surface (S12) opposite to the first end surface (S11) in a first direction (X direction), a first side surface (S21), a second side surface (S22) opposite to the first side surface (S21) in a second direction (Y direction), a first main surface (S31), and a second main surface (S32) opposite to the first main surface (S31) in a third direction (Z direction). The layered varistor (1) has a layered structure including a plurality of layers (111) stacked on one another in the third direction (Z direction) via a plurality of interfaces (Tx). The first internal electrode (21), the second internal electrode (22), and the third internal electrode (23) are disposed inside the sintered body (11) and on a first interface (T1) out of the interfaces (Tx), and do not contact one another. The fourth internal electrode (24) is disposed inside the sintered body (11) and on a second interface (T2) out of the interfaces (Tx) which his different from the first interface (T1), and overlaps a part of first internal electrode (21) and a part of third internal electrode (23) when viewed in the third direction (Z direction). The fifth internal electrode (25) is disposed inside the sintered body (11) and on a third interface (T3) out of the interfaces (Tx) which is different from the first interface (T1), and overlaps a part of second internal electrode (22) and a part of third internal electrode (23) when viewed in the third direction (Z direction). The first external electrode (31) is disposed on at least one of the first end surface (S11), the first side surface (S21), and the second side surface (S22), and is electrically connected to the first internal electrode (21). The second external electrode (32) is disposed on at least one of the second end surface (S12), the first side surface (S21), and the second side surface (S22), and is electrically connected to the second internal electrode (22). The third external electrode (33) is disposed on at least one of the first side surface (S21) and the second side surface (S22), and is electrically connected to the third internal electrode (23). The fourth internal electrode (24) and the fifth internal electrode (25) do not overlap each other when viewed in the third direction (Z direction).

According to the first aspect, these internal electrodes displace in the same direction even when layer displacement occurs due to variation in dimensions, shapes, and positions of the internal electrodes and external electrodes formed during the manufacture of the layered varistor (1). This configuration suppresses an increase or decrease in a difference of facing areas configuring two varistor elements, thereby reducing a capacitance difference between the two varistor elements caused by variation in dimensions and reducing the occurrence of crosstalk.

In the layered varistor (1) according to a second aspect, in the first aspect, the first internal electrode (21) includes a first overlap (P1) and a first connection (Q1). The first overlap (P1) overlaps the fourth internal electrode (24) when viewed in the third direction. The first connection (Q1) connects the first overlap (P1) to the first external electrode (31). The second internal electrode (22) includes a second overlap (P2) and a second connection (Q2). The second overlap (P2) overlaps the fifth internal electrode (25) when viewed in the third direction (Z direction). The second connection (Q2) connects the second overlap (P2) to the second external electrode (32). Third internal electrode (23) includes a third overlap (P3), a fourth overlap (P4), and a third connection (Q3). The third overlap (P3) overlaps the fourth internal electrode (24) when viewed in the third direction (Z direction). The fourth overlap (P4) overlaps the fifth internal electrode (25) when viewed in the third direction (Z direction). The third connection (Q3) connects the third overlap (P3) and the fourth overlap (P4) to the third external electrode (33). The fourth internal electrode (24) includes a fifth overlap (P5) and a sixth overlap (P6). The fifth overlap (P5) faces the first overlap (P1) when viewed in the third direction (Z direction). The sixth overlap (P6) faces the third overlap (P3) when viewed in the third direction (Z direction). The fifth internal electrode (25) includes a seventh overlap (P7) and an eighth overlap (P8). The seventh overlap (P7) faces the second overlap (P2) when viewed in the third direction (Z direction). The eighth overlap (P8) faces the fourth overlap (P4) when viewed in the third direction (Z direction).

According to the second aspect, a capacitance difference between the two varistor elements caused by variation in dimensions, is reduce, and the occurrence of crosstalk is reduced.

In the layered varistor (1) according to a third aspect, in the first or second aspect, the first internal electrode (21) includes a first facing part (U1) and a first lead-out part (V1). The first facing part (U1) faces the fourth internal electrode (24) when viewed in the third direction (Z direction). The first lead-out part (V1) connects the first facing part (U1) to the first external electrode (31). A length of the first lead-out part (V1) in the second direction (Y direction) is smaller than a length of the first facing part (U1) in the second direction (Y direction). The second internal electrode (22) includes a second facing part (U2) and a second lead-out part (V2). The second facing part (U2) faces the fifth internal electrode (25) when viewed in the third direction (Z direction). The second lead-out part (V2) connects the second facing part (U2) to the second external electrode (32). A length of the second lead-out part (V2) in the second direction (Y direction) is smaller than a length of the second facing part (U2) in the second direction (Y direction). The third internal electrode (23) includes a third facing part (U3)), a first joint (W1), a fourth facing part (U4), a second joint (W2), a third lead-out (V3), a second joint (W2), and a third external electrode (33). The third facing part (U3) faces the fourth internal electrode (24) when viewed in the third direction (Z direction). The fourth facing part (U4) faces the fifth internal electrode (25) when viewed in the third direction (Z direction). The third lead-out (V3) connects the first joint (W1) and the second joint (W2) to the third external electrode (33). A length of the first joint (W1) in the second direction (Y direction) is smaller than a length of the third facing part (U3) in the second direction (Y direction). A length of the second joint (W2) in the second direction (Y direction) is smaller than a length of the fourth facing part (U4) in the second direction (Y direction). The fourth internal electrode (24) includes a fifth facing part (U5), a sixth facing part (U6), and a third joint (W3). The fifth facing part (U5) faces the first facing part (U1) when viewed in the third direction (Z direction). The sixth facing part (U6) faces the third facing part (U3) when viewed in the third direction (Z direction). The third joint (W3) connects the fifth facing part (U5) to sixth facing part (U6). The fifth internal electrode (25) includes a seventh facing part (U7), an eighth facing part (U8), and a fourth joint (W4). The seventh facing part (U7) faces the second facing part (U2) when viewed in the third direction (Z direction). The eighth facing part (U8) faces the fourth facing part (U4) when viewed in the third direction (Z direction). The fourth joint (W4) connects the seventh facing part (U7) to the eighth facing part (U8).

According to the third aspect, widths of the first lead-out part (V1), the second lead-out part (V2), the first joint (W1), and the second joint (W2) are reduced. This configuration suppresses, even when layer displacement due to variation in dimensions occurs, a change in facing areas of the two varistor elements, resultantly reducing a capacitance difference and reducing the occurrence of crosstalk.

In the layered varistor (1) according to a fourth aspect, in one of the first to third aspects, the second interface T2 and the third interface (T3) are a same interface (T23).

According to the fourth aspect, the fourth internal electrode (24) and the fifth internal electrode (25) are disposed on the same interface (T23). Thus, the facing areas unlikely change even when layer displacement occurs. As a result, a capacitance difference is reduced, and the occurrence of crosstalk is reduced.

In the layered varistor (1) according to a fifth aspect, in one of the first to third aspects, the second interface (T2) and the third interface (T3) are different interfaces.

According to the fifth aspect, the second interface (T2) and the third interface (T3) are different interfaces. This configuration secures a large distance between the fourth internal electrode (24) and the fifth internal electrode (25), thereby suppressing the occurrence of crosstalk.

In the layered varistor (1) according to a six aspect, in one of the first to fifth aspects, a length of the fourth internal electrode (24) in the second direction (Y direction) is larger than a length of the first internal electrode (21) in the second direction (Y direction). A length of the fifth internal electrode (25) in the second direction (Y direction) is larger than a length of the second internal electrode (22) in the second direction (Y direction).

According to the six aspect, dimensions of the fourth and fifth internal electrodes (24 and 25) are larger than dimensions of the first to third internal electrodes (21 to 23). This configuration suppresses a change in facing areas even when layer displacement occurs, resultantly reducing a capacitance difference and reducing the occurrence of crosstalk.

In the layered varistor (1) according to a seventh aspect, in one of first to fifth aspects, a length (Y1) of the fourth internal electrode (24) in the second direction (Y direction) is smaller than a length (X1) of the first internal electrode (21) in the second direction (Y direction). A length (Y1) of the fifth internal electrode (25) in the second direction (Y direction) is smaller than a length (X1) of the second internal electrode (22) in the second direction (Y direction).

According to the seventh aspect, a change in the facing areas is suppressed even when layer displacement occurs by making dimensions of the fourth and fifth internal electrodes (24 and 25) smaller than dimensions of the first to third internal electrodes (21 to 23). As a result, a capacitance difference is reduced, and the occurrence of crosstalk is reduced.

In the layered varistor (1) according to an eighth aspect, in one of second to seventh aspects, a length (Y1) of the fourth internal electrode (24) in the second direction (Y direction) is larger than a length (Z1) of the third overlap (P3) of the third internal electrode (23) in the second direction (Y direction). A length (Y1) of the fifth internal electrode (25) is larger than a length (Z1) of the fourth overlap (P4) of the third internal electrode (23) in the second direction (Y direction).

According to the eighth aspect, a change in the facing areas is suppressed even when layer displacement occurs by making dimensions of the fourth and fifth internal electrodes (24 and 25) larger than dimensions of the first to third internal electrodes (21 to 23). As a result, a capacitance difference is reduced, and the occurrence of crosstalk is reduced.

In the layered varistor (1) according to a ninth aspect, in one of the second to seventh aspects, a length (Y1) of the fourth internal electrode (24) in the second direction (Y direction) is smaller than a length (Z1) of the third overlap (P3) of the third internal electrode (23) in the second direction (Y direction). A length (Y1) of the fifth internal electrode (25) in the second direction (Y direction) is smaller than a length (Z1) of the fourth overlap (P4) of the third internal electrode (23) in the second direction (Y direction).

According to the ninth aspect, a change in the facing areas is suppressed even when layer displacement occurs by making dimensions of the fourth and fifth internal electrodes (24 and 25) smaller than a dimension of a facing portion of the third internal electrode (23). As a result, a capacitance difference is reduced, and the occurrence of crosstalk is reduced.

In the layered varistor (1) according to a tenth aspect, in one of the third to ninth aspects, a length (Y3) of the fifth facing part (U5) of the fourth internal electrode (24) is smaller than a length (X3) of the first facing part (U1) of the first internal electrode (21) in the first direction (X direction). A length (Y3) of the seventh facing part (U7) of the fifth internal electrode (25) is smaller than a length (X3) of the second facing part (U2) of the second internal electrode (22) in the first direction (X direction).

According to the tenth aspect, a change in the facing areas is suppressed even when layer displacement occurs. As a result, a capacitance difference is reduced, and the occurrence of crosstalk is reduced.

In the layered varistor (1) according to an eleventh aspect, in one of the third to ninth aspects, a length (Y4) of the sixth facing part (U6) of the fourth internal electrode (24) in the first direction (X direction) is smaller than a length (X4) of the third facing part (U3) of the third internal electrode (23) in the first direction (X direction). A length (Y4) of the eighth facing part (U8) of the fifth internal electrode (25) in the first direction (X direction) is smaller than a length (X4) of the fourth facing part (U4) of the third internal electrode (23) in the first direction (X direction).

According to the eleventh aspect, a change in the facing areas is suppressed even when layer displacement occurs. As a result, a capacitance difference is reduced, and the occurrence of crosstalk is reduced.

In the layered varistor (1) according to a twelfth aspect, in one of the third to ninth aspects, a length (Y3) of the fifth facing part (U5) of the fourth internal electrode (24) in the first direction (X direction) is larger than a length (X3) of the first facing part (U1) of the first internal electrode (21) in the first direction (X direction). A length (Y3) of the seventh facing part (U7) of the fifth internal electrode (25) in the first direction (X direction) is larger than a length (X3) of the second facing part (U2) of the second internal electrode (22) in the first direction (X direction).

According to the twelfth aspect, a change in the facing areas is suppressed even when layer displacement occurs. As a result, a capacitance difference is reduced, and the occurrence of crosstalk is reduced.

In the layered varistor (1) according to a thirteenth aspect, in one of the third to ninth aspects, a length (Y4) of the sixth facing part (U6) of the fourth internal electrode (24) in the first direction (X direction) is larger than a length (X4) of the third facing part (U3) of the third internal electrode (23) in the first direction (X direction). A length (Y4) of the eighth facing part (U8) of the fifth internal electrode (25) in the first direction (X direction) is larger than a length (X4) of the fourth facing part (U4) of the third internal electrode (23) in the first direction (X direction).

According to the thirteenth aspect, a change in the facing areas is suppressed even when layer displacement occurs. As a result, a capacitance difference is reduced, and the occurrence of crosstalk is reduced.

In the layered varistor (1) according to a fourteenth aspect, in one of the third to thirteenth aspects, a length (Y2) of the fifth facing part (U5) of the fourth internal electrode (24) in the second direction (Y direction) is smaller than a length (X2) of the first facing part (U1) of the first internal electrode (21) in the second direction (Y direction). A length (Y2) of the seventh facing part (U7) of the fifth internal electrode (25) in the second direction (Y direction) is smaller than a length (X2) of the second facing part (U2) of the second internal electrode (22) in the second direction (Y direction).

According to the fourteenth aspect, a change in the facing areas is suppressed even when layer displacement occurs. As a result, a capacitance difference is reduced, and the occurrence of crosstalk is reduced.

In the layered varistor (1) according to a fifteenth aspect, in one of the third to thirteenth aspects, a length (Y2) of the fifth facing part (U5) of the fourth internal electrode (24) in the second direction (Y direction) is larger than a length (X2) of the first facing part (U1) of the first internal electrode (21) in the second direction (Y direction). A length (Y2) of the seventh facing part (U7) of fifth internal electrode (25) in the second direction (Y direction) is larger than a length (X2) of the second facing part (U2) of the second internal electrode (22) in the second direction (Y direction).

According to the fifteenth aspect, a change in the facing areas is suppressed even when layer displacement occurs. As a result, a capacitance difference is reduced, and the occurrence of crosstalk is reduced.

In the layered varistor (1) according to a sixteenth aspect, in one of the third to fifteenth aspects, a length of third joint (W3) of the fourth internal electrode (24) in the second direction (Y direction) is smaller than a length of the fifth facing part (U5) of the fourth internal electrode (24) in the second direction (Y direction) and a length of the sixth facing part (U6) of the fourth internal electrode (24) in the second direction (Y direction). A length of the fourth joint (W4) of the fifth internal electrode (25) in the second direction (Y direction) is smaller than a length of the seventh facing part (U7) of the fifth internal electrode (25) in the second direction (Y direction) and a length of the eighth facing part (U8) of the fifth internal electrode (25) in the second direction (Y direction).

According to the sixteenth aspect, even when layer displacement occurs particularly in the first direction (X direction), a change in the facing areas is suppressed. As a result, a capacitance difference is reduced, and the occurrence of crosstalk is reduced.

In the layered varistor (1) according to a seventeenth aspect, in one of the first to sixteenth aspects, a distance (B1) between the first internal electrode (21) and the third internal electrode (23) in the first direction (X direction) is larger than a distance (A1) between the first interface (T1) and the second interface (T2) in the third direction (Z direction). A distance (B1) between the second internal electrode (22) and the third internal electrode (23) in the first direction (X direction) is larger than a distance (A1) between the first interface (T1) and the second interface (T2) in the third direction (Z direction).

According to the seventeenth aspect, an interval between the internal electrodes is larger than an interval between the interfaces. As a result, a capacitance difference is reduced, and the occurrence of crosstalk is reduced.

In the layered varistor (1) according to an eighteenth aspect, in one of the first to seventeenth aspects, a shortest distance (B3) between the first internal electrode (21) and the third external electrode (33) is larger than a shortest distance (A2) between the first internal electrode (21) and the third internal electrode (23). A shortest distance (B3) between the second internal electrode (22) and the third external electrode (33) is larger than a shortest distance (A2) between the second internal electrode (22) and the third internal electrode (23).

According to the eighteenth aspect, the distance between the first internal electrode (21) and the third external electrode (33) where a potential difference is generated is larger than the distance between the first and third internal electrodes (21 and 23). As a result, a capacitance difference is reduced, and the occurrence of crosstalk is reduced.

In the layered varistor (1) according to a nineteenth aspect, in one of the first to eighteenth aspects, a shortest distance (C2) between the third internal electrode (23) and the first external electrode (31) is larger than a shortest distance (A2) between the first internal electrode (21) and the third internal electrode (23). A shortest distance (C2) between the third internal electrode (23) and the second external electrode (32) is larger than a shortest distance (A2) between the second internal electrode (22) and the third internal electrode (23).

According to the nineteenth aspect, the distance between the third internal electrode (23) and one of the first external electrode (31) or the second external electrode (32) where a potential difference is generated is larger than the distance between the first and third internal electrodes (21 and 23). As a result, a capacitance difference is reduced, and the occurrence of crosstalk is reduced.

In the layered varistor (1) according to a twentieth aspect, in one of the first to nineteenth aspects, a shortest distance (B3) between the first internal electrode (21) and the third external electrode (33) is larger than a shortest distance (A2) between the first internal electrode (21) and the third internal electrode (23). A shortest distance (B3) between the second internal electrode (22) and the third external electrode (33) is larger than a shortest distance (A2) between the second internal electrode (22) and the third internal electrode (23).

According to the twentieth aspect, the distance between the third external electrode (33) and one of the first internal electrode (21) or the second internal electrode (22) where a potential difference is generated is larger than the distance between the first and third internal electrodes (21 and 23). As a result, a capacitance difference is reduced, and the occurrence of crosstalk is reduced.

In the layered varistor (1) according to a twenty-first aspect, in one of the first to twentieth aspects, a shortest distance (C2) between the third internal electrode (23) and the first external electrode (31) is larger than a shortest distance (A2) between the first internal electrode (21) and the third internal electrode (23). A shortest distance (C2) between the third internal electrode (23) and the second external electrode (32) is larger than a shortest distance (A2) between the second internal electrode (22) and the third internal electrode (23).

According to the twenty-first aspect, a capacitance difference is reduced, and the occurrence of crosstalk is suppressed by securing a large distance between the third internal electrode (23) and the first external electrode (31) where a potential difference is generated.

In the layered varistor (1) according to a twenty-second aspect, in one of the first to twenty-first aspects, the third external electrode (33) overlaps none of the fourth internal electrode (24) and the fifth internal electrode (25) when viewed in the third direction (Z direction) and in the second direction (Y direction).

According to the twenty-second aspect, a capacitance difference is reduced, and the occurrence of crosstalk is reduced by further reducing a distance between the third external electrode (33) and each of the fourth and fifth internal electrodes (24 and 25).

In layered varistor (1) according to a twenty-third aspect, in one of the first to twenty-second aspects, the first external electrode (31) and the second external electrode (32) overlap none of the fourth internal electrode (24) and the fifth internal electrode (25) when in the third direction (Z direction) and in the second direction (Y direction).

According to the twenty-third aspect, a capacitance difference is reduced, and the occurrence of crosstalk is reduced by securing a large distance from the first external electrode (31) and the second external electrode (32) to the fourth internal electrode (24) and the fifth internal electrode (25).

In the layered varistor (1) according to a twenty-fourth aspect, the first external electrode (31) and the second external electrode (32) are disposed on at least one of the first side surface (S21) and the second side surface (S22) in one of the first to twenty-third aspects.

According to the twenty-fourth aspect, a large distance is secured from the third external electrode (33) to the fourth internal electrode (24) and the fifth internal electrode (25) even when the third external electrode (33) is disposed as described above. As a result, a capacitance difference is reduced, and the occurrence of crosstalk is reduced.

In the layered varistor (1) according to a twenty-fifth aspect, in one of the first to twenty-fourth aspect, the second interface (T2) and the third interface (T3) are same interface (T23), and the layers (111) of the sintered body (11) are stacked via first interfaces (T1) each of which is the first interface (T1) and plural same interfaces (T23) each of which is the same interface (T23), so that the first interfaces (T1) and the same interfaces (T23) are alternately arranged.

According to the twenty-fifth aspect, plural groups of first to fifth internal electrodes (21 to 25) improve various performances of the layered varistor (1) while reducing a capacitance difference and the occurrence of crosstalk.

In the layered varistor (1) according to a twenty-sixth aspect, in the twenty-fifth aspect, one of two of the first interfaces (T1) is disposed closest to first main surface (S31) and another of the two of the first interfaces (T1) closest to the second main surface (S32) along the third direction (Z direction).

According to the twenty-sixth aspect, first to third internal electrodes (21 to 23) are disposed on the outermost sides. As a result, the effect of reducing a capacitance difference and crosstalk is maximized.

In the layered varistor (1) according to a twenty-seventh aspect, in the twenty-fifth aspect, one of the first interfaces (T1) is disposed closest to first main surface (S31) along the third direction (Z direction) and one of the same interfaces (T23) is closest to second main surface (S32). Or one of the first layered faces (T1) is closest to the second main surface (S32) along the third direction (Z direction) and one of the same interfaces (T23) is closest to the first main surface (S31).

According to the twenty-seventh aspect, one of the first to third internal electrodes (21 to 23) is disposed on the outermost side. As a result, the effect of reducing a capacitance difference and crosstalk is enhanced.

In the layered varistor (1) according to a twenty-eighth aspect, in the twenty-fourth aspect, one of two of the same interfaces (T23) is closest to first main surface (S31) and another of the two of the same interfaces (T23) is closest to the second main surface (S32) along the third direction (Z direction).

According to the twenty-eighth aspect, the effect of reducing a capacitance difference and crosstalk is enhanced.

### Examples

The present disclosure will be detailed below with reference to examples. However, the present disclosure is not limited to the examples.

### Measurement of Capacitance Difference Between Two Varistor Elements in Layered Varistor

A capacitance difference between two varistor elements was measured with respect to layered varistors (I) to (III) below. Table 1 below shows measurement results in relative values based on a value of layered varistor (I).

Layered varistor (I): Conventional layered varistor (Normal structure: Single layer)

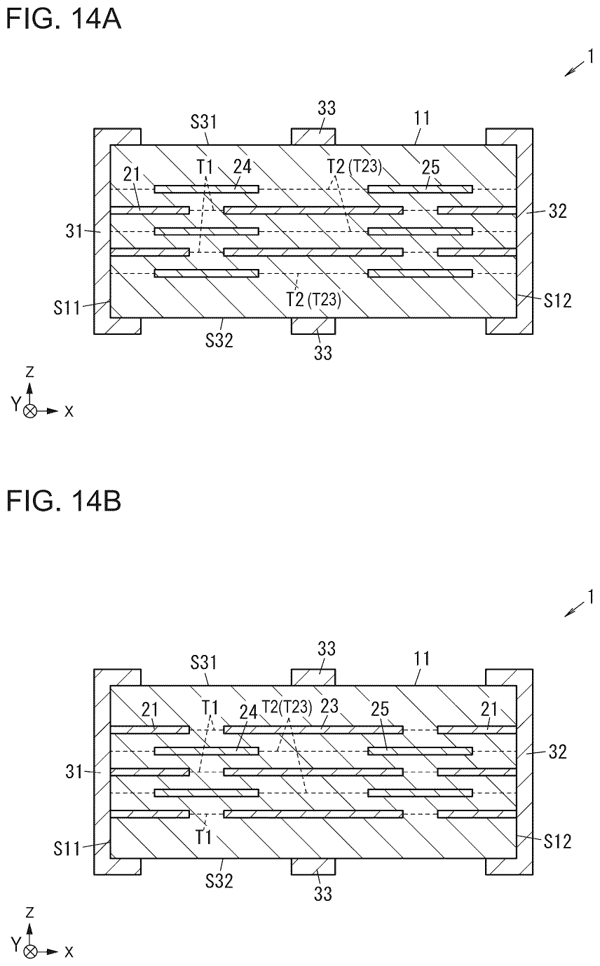

Layered varistor (II): Sectional structure in Z direction: FIG. 1A, and sectional structure in Y direction: FIG. 14A

Layered varistor (III): Sectional structure in Z direction: FIG. 4A, and sectional structure in Y direction: FIG. 14B

TABLE 1

| | Layered | Layered | Layered |
|---|---|---|---|
| | Varistor | Varistor | Varistor |
| (Relative Value) | (I) | (II) | (III) |
| Capacitance Difference between | 100 | 87 | 71 |
| Two Varistor Elements | | | |

It is apparent from results in Table 1 that layered varistors according to the exemplary embodiments, such as layered varistors (II) and (III), reduce a capacitance difference between two varistor elements caused by variation in dimensions more than a conventional layered varistor, such as layered varistor (I). Accordingly, it was confirmed that the layered varistors according to the exemplary embodiments reduced the occurrence of crosstalk.

### REFERENCE MARKS IN THE DRAWINGS

1 layered varistor
11 sintered body
21 first internal electrode
22 second internal electrode
23 third internal electrode
24 fourth internal electrode
25 fifth internal electrode
31 first external electrode
32 second external electrode
33 third external electrode

1. A layered varistor comprising:
a sintered body having a rectangular parallelepiped shape having a first end surface, a second end surface opposite to the first end surface in a first direction, a first side surface, a second side surface opposite to the first side surface in a second direction, a first main surface, and a second main surface opposite to first main surface in a third direction, the sintered body having a layered structure including a plurality of layers stacked on one another via a plurality of interfaces in the third direction;
a first internal electrode, a second internal electrode, and a third internal electrode which are disposed inside the sintered body and on a first interface out of the plurality of interfaces, the first internal electrode, the second internal electrode, and the third internal electrode not contacting one another;
a fourth internal electrode disposed inside the sintered body and on a second interface out of the plurality of interfaces which is different from the first interface, the fourth internal electrode overlapping a part of the first internal electrode and a part of the third internal electrode when viewed in the third direction;
a fifth internal electrode disposed inside the sintered body and on a third interface out of the plurality of interfaces which is different from the first interface, the fifth internal electrode overlapping a part of the second internal electrode and a part of the third internal electrode when viewed in the third direction;
a first external electrode disposed on at least one of the first end surface, the first side surface, and the second side surface, the first external electrode being electrically connected to the first internal electrode;
a second external electrode disposed on at least one of the second end surface, the first side surface, and the second side surface, the second external electrode being electrically connected to the second internal electrode; and
a third external electrode disposed on at least one of the first side surface and the second side surface, the third external electrode being electrically connected to the third internal electrode,
wherein the fourth internal electrode and the fifth internal electrode do not overlap each other when viewed in the third direction.

2. The layered varistor according to claim 1,
wherein the first internal electrode includes a first overlap and a first connection, the first overlap that overlapping the fourth internal electrode when viewed in the third direction, the first connection connecting the first overlap to the first external electrode,
wherein the second internal electrode includes a second overlap and a second connection, the second overlap overlapping the fifth internal electrode when viewed in the third direction, the second connection connecting the second overlap to the second external electrode,
wherein the third internal electrode includes a third overlap, a fourth overlap, and a third connection, the third overlap overlapping the fourth internal electrode when viewed in the third direction, the fourth overlap overlapping the fifth internal electrode when viewed in the third direction, the third connection connecting the third overlap and the fourth overlap to the third external electrode,
wherein the fourth internal electrode includes a fifth overlap and a sixth overlap, the fifth overlap facing the first overlap in the third direction, the sixth overlap facing the third overlap in the third direction, and
wherein the fifth internal electrode includes a seventh overlap and an eighth overlap, the seventh overlap facing the second overlap in the third direction, the eighth overlap facing the fourth overlap in the third direction.

3. The layered varistor according to claim 1,
wherein the first internal electrode includes a first facing part and a first lead-out part, the first facing part facing the fourth internal electrode in the third direction, the first lead-out part connects the first facing part to the first external electrode, a length of the first lead-out part in the second direction being smaller than a length of the first facing part in the second direction,
wherein the second internal electrode includes a second facing part and a second lead-out part, the second facing part facing the fifth internal electrode in the third direction, the second lead-out part connecting the second facing part to the second external electrode, a length of the second lead-out part in the second direction being smaller than a length of the second facing part in the second direction,
wherein the third internal electrode includes a third facing part, a first joint, a fourth facing part, a second joint, and a third lead-out part, the third facing part facing the fourth internal electrode in the third direction, a length of the first joint in the second direction being smaller than a length of the third facing part in the second direction, the fourth facing part facing the fifth internal electrode in the third direction, a length of the second joint in the second direction being smaller than a length of the fourth facing part in the second direction, the third lead-out part connecting the first joint and the second joint to the third external electrode,
wherein the fourth internal electrode includes a fifth facing part, a sixth facing part, and a third joint, the fifth facing part facing the first facing part in the third direction, the sixth facing part facing the third facing part in the third direction, the third joint connecting the fifth facing part to the sixth facing part, and
wherein the fifth internal electrode includes a seventh facing part, an eighth facing part, and a fourth joint, the seventh facing part facing the second facing part in the third direction, the eighth facing part facing the fourth facing part in the third direction, the fourth joint connecting the seventh facing part to the eighth facing part.

4. The layered varistor according to claim 1, wherein the second interface and the third interface are a same layered surface.

5. The layered varistor according to claim 1, wherein the second interface and the third interface are different layered surfaces.

6. The layered varistor according to claim 1,
wherein a length of the fourth internal electrode in the second direction is larger than a length of the first internal electrode in the second direction, and
wherein a length of the fifth internal electrode in the second direction is larger than a length of the second internal electrode in the second direction.

7. The layered varistor according to claim 1,
wherein a length of the fourth internal electrode in the second direction is smaller than a length of the first internal electrode in the second direction, and
wherein a length of the fifth internal electrode in the second direction is smaller than a length of the second internal electrode in the second direction.

8. The layered varistor according to claim 2,
wherein a length of the fourth internal electrode in the second direction is larger than a length of the third overlap of the third internal electrode in the second direction, and
wherein a length of the fifth internal electrode in the second direction is larger than a length of the fourth overlap of the third internal electrode in the second direction.

9. The layered varistor according to claim 2,
wherein a length of the fourth internal electrode in the second direction is smaller than a length of the third overlap of the third internal electrode in the second direction, and
wherein a length of the fifth internal electrode in the second direction is smaller than a length of the fourth overlap of the third internal electrode in the second direction.

10. The layered varistor according to claim 3,
wherein a length of the fifth facing part of the fourth internal electrode in the first direction is smaller than a length of the first facing part of the first internal electrode in the first direction, and
wherein a length of the seventh facing part of the fifth internal electrode in the first direction is smaller than a length of the second facing part of the second internal electrode in the first direction.

11. The layered varistor according to claim 3,
wherein a length of the sixth facing part of the fourth internal electrode in the first direction is smaller than a length of the third facing part of the third internal electrode in the first direction, and
wherein a length of the eighth facing part of the fifth internal electrode in the first direction is smaller than a length of the fourth facing part of the third internal electrode in the first direction.

12. The layered varistor according to claim 3,
wherein a length of the fifth facing part of the fourth internal electrode in the first direction is larger than a length of the first facing part of the first internal electrode in the first direction, and
wherein a length of the seventh facing part of the fifth internal electrode in the first direction is larger than a length of the second facing part of the second internal electrode in the first direction.

13. The layered varistor according to claim 3,
wherein a length of the sixth facing part of the fourth internal electrode in the first direction is larger than a length of the third facing part of the third internal electrode in the first direction, and
wherein a length of the eighth facing part of the fifth internal electrode in the first direction is larger than a length of the fourth facing part of the third internal electrode in the first direction.

14. The layered varistor according to claim 3,
wherein a length of the fifth facing part of the fourth internal electrode in the second direction is smaller than a length of the first facing part of the first internal electrode in the second direction, and
wherein a length of the seventh facing part of the fifth internal electrode in the second direction is smaller than a length of the second facing part of the second internal electrode in the second direction.

15. The layered varistor according to claim 3,
wherein a length of the fifth facing part of the fourth internal electrode in the second direction is larger than a length of the first facing part of the first internal electrode in the second direction, and
wherein a length of the seventh facing part of the fifth internal electrode in the second direction is larger than a length of the second facing part of the second internal electrode in the second direction.

16. The layered varistor according to claim 3,
wherein a length of the third joint of the fourth internal electrode in the second direction is smaller than a length of the fifth facing part of the fourth internal electrode in the second direction and a length of the sixth facing part of the fourth internal electrode in the second direction, and
wherein a length of the fourth joint of the fifth internal electrode in the second direction smaller than a length of the seventh facing part of the fifth internal electrode in the second direction and a length of the eighth facing part of the fifth internal electrode in the second direction.

17. The layered varistor according to claim 1,
wherein a distance between the first internal electrode and the third internal electrode in the first direction is larger than a distance between the first interface and the second interface in the third direction, and
wherein a distance between the second internal electrode and the third internal electrode in the first direction is larger than a distance between the first interface and the second interface in the third direction.

18. The layered varistor according to claim 1,
wherein a shortest distance between the first internal electrode and the third external electrode is larger than a shortest distance between the first internal electrode and the third internal electrode, and
wherein a shortest distance between the second internal electrode and the third external electrode is larger than a shortest distance between the second internal electrode and the third internal electrode.

19. The layered varistor according to claim 1,
wherein a shortest distance between the third internal electrode and the first external electrode is larger than a shortest distance between the first internal electrode and the third internal electrode, and
wherein a shortest distance between the third internal electrode and the second external electrode is larger than a shortest distance between the second internal electrode and the third internal electrode.

20. The layered varistor according to claim 1,
wherein a shortest distance between the first internal electrode and the third external electrode is larger than a shortest distance between the first internal electrode and the third internal electrode, and
wherein a shortest distance between the second internal electrode and the third external electrode is larger than a shortest distance between the second internal electrode and the third internal electrode.

21. The layered varistor according to claim 1,
wherein a shortest distance between the third internal electrode and the first external electrode is larger than a shortest distance between the first internal electrode and the third internal electrode, and
wherein a shortest distance between the third internal electrode and the second external electrode is larger than a shortest distance between the second internal electrode and the third internal electrode.

22. The layered varistor according to claim 1, wherein the third external electrode overlaps none of the fourth internal electrode and the fifth internal electrode when viewed in each of the third direction and the second direction.

23. The layered varistor according to claim 1, wherein the first external electrode and the second external electrode overlap none of the fourth internal electrode and the fifth internal electrode when viewed in each of the third direction and the second direction.

24. The layered varistor according to claim 1, wherein the first external electrode and the second external electrode are disposed on at least one of the first side surface and the second side surface.

25. The layered varistor according to claim 1,
wherein the second interface and the third interface are a same interface,
wherein the plurality of layers of the sintered body is stacked via a plurality of first interfaces each of which is the first interface and a plurality of same interfaces each of which is the same interface, and
wherein the plurality of first interfaces and the plurality of same interfaces are alternately arranged.

26. The layered varistor according to claim 25, wherein two of the plurality of first interfaces are closest to the first main surface and the second main surface along the third direction, respectively.

27. The layered varistor according to claim 25,
wherein one of the plurality of first interfaces is closest to the first main surface along the third direction, and one of the plurality of same interfaces is closest to the second main surface, or
wherein one of the plurality of first interfaces is closest to the second main surface along the third direction, and one of the plurality of same interfaces is closest to the first main surface.

28. The layered varistor according to claim 25, wherein two of the plurality of same interfaces are closest to the first main surface and the second main surface along the third direction, respectively.
